(19) United States
(12) Patent Application Publication
(10) Pub. No.: US 2016/0113292 A1
(43) Pub. Date: Apr. 28, 2016

(54) Roller Arrangement Having a Movable Inlet Plate

(71) Applicant: HAAS FOOD EQUIPMENT GMBH, Wien (AT)

(72) Inventors: JOHANNES HAAS, WIEN (AT); JOSEF HAAS, LEOBENDORF (AT); STEFAN JIRASCHEK, KOENIGSBRUNN (AT); PETER LAMBAUER, HITZENDORF (AT)

(73) Assignee: HAAS FOOD EQUIPMENT GMBH, Wien (AT)

(21) Appl. No.: 14/891,694

(22) PCT Filed: May 8, 2014
(86) PCT No.: PCT/EP2014/059445

§ 371 Date: Nov. 17, 2015

(30) Foreign Application Priority Data
May 17, 2013 (AT) A413/2013

(51) Int. Cl. A21C 3/02; B29B 13/00

(52) U.S. Cl. CPC A21C 3/025; B29B 13/00

(57) ABSTRACT

An apparatus to form a flat rolled-out continuously conveyed dough strip has a first roller and a second roller driven in mutually opposite rotary directions. A roller nip between the first and second rollers roll out a dough strip. A terminating ring is disposed concentrically with the first roller and the first roller projects radially for lateral sealing of the roller nip. A conveying device supplies the dough strip to the inlet region of the roller nip, where a movable inlet plate provided. The inlet plate is movable by a moving device from an operating position in which the inlet plate laterally seals the inlet region of the roller nip into a maintenance position in which the inlet plate is disposed at a distance from the roller nip. A clamping device moves the inlet plate onto the second roller in the operating position.

The invention relates to an apparatus to form a flat rolled-out continuously conveyed dough strip comprising a first roller which is rotationally driven about a first axis of rotation, a second roller which is rotationally driven about a second axis of rotation, wherein the direction of rotation of the first roller is opposite the direction of rotation of the second roller and wherein between the first roller and the second roller a roller gap is provided for feeding through and rolling out a dough strip, a terminating ring which is disposed concentrically with the first roller and the first roller projects in the radial direction for lateral sealing of the roller gap and a conveying device for supplying the dough strip to the inlet region of the roller gap. The invention further relates to an inlet plate for the roller arrangement according to the invention which is preferably movable by means of a moving apparatus.

Apparatus for forming a flat rolled-out continuously conveyed dough strip are known and published in various designs.

For example, rolling-out devices are known which in the technical language are also designated as Duomat. In this case an upper and a lower roller are in each case mounted laterally rotationally and driven on a machine frame. A roller gap for feeding through the dough strip is kept free between the two rollers. The supplied dough strip has a greater thickness than the height of the roller gap. The dough strip is thereby rolled out. During rolling out the dough strip becomes thinner. This results in an increase in the speed of the dough strip after the pair of rollers and possibly in a broadening, i.e. in a lateral broadening of the strip. In order to optimally use the roller width, the incoming dough strip is guided as far as close to the lateral edges of the rollers. There is therefore no space for a lateral expansion of the dough strip.

For this reason roller arrangements are known in which the roller gap is sealed laterally in order to prevent the lateral expansion of the dough strip during rolling out. A laterally closed roller gap is thereby formed. High pressures of several bar occur in this roller gap. Consequently both the rollers and also the inlet plates which laterally seal the roller gap must be sufficiently dimensioned and stable.

In conventional roller arrangements the inlet plate is rigidly connected to the machine frame and supported on this in order to be able to intercept compressive forces. A disadvantage of this design is that during maintenance or when starting up, access to the crucial parts is prevented by the inlet plate. For example, if the conveyor belt of the transport device by which means the dough strip is supplied, is to be exchanged, the inlet plate and optionally the entire roller arrangement must be dismounted. However, in particular a rapid exchange of the feed belts is absolutely necessary to increase the efficiency of the entire installation.

Furthermore roller arrangements are known in which the width and/or the shape of the roller gap can be matched to one another by means of relative movement of the rollers. The sealing of the roller gap and the inlet region in these devices is insufficiently achieved by conventional inlet plates.

It is now an object of the invention to provide a device for forming a flat rolled-out continuously conveyed dough strip which allows a high-quality rolling out of the dough strip and in particular has a laterally sealed inlet region of the roller gap, in which however the maintenance and cleaning of the crucial parts located in the inlet region is furthermore simplified. This is particularly important to simplify the cleaning and the accessibility of barely accessible regions of the device.

Furthermore, as a result of the advantageous embodiment of the device, the sealing of the inlet region of the roller gap is optionally also possible in roller arrangements in which the rollers are movable relative to one another to change the roller gap.

The objects according to the invention are solved by the features of patent claim 1.

In particular since a movable inlet plate is provided which is connected to the machine frame via a moving device, wherein the inlet plate is movable by means of a moving device from an operating position in which the inlet plate laterally seals the inlet region of the roller gap into a maintenance position in which the inlet plate is disposed at a distance from the roller gap, and that a clamping device is provided by which means the inlet plate is moved onto the second roller in the operating position.

Further advantageous features are that the clamping device comprises a pressure element by which means the inlet plate is pressed onto the lateral front side of the second roller to seal the inlet region of the roller gap, that the clamping device comprises a movable clamping element on which the pressure element is provided by which means the inlet plate can be pressed onto the second roller by movement of the clamping element, that the movable clamping element is a lever mounted pivotably on the machine frame from which the pressure element projects laterally, that the terminating ring has a lateral surface, that the inlet plate has a circular-section-shaped cut-out whose radius of curvature substantially corresponds to the radius of curvature of the lateral surface of the terminating ring and/or that in the operating position the cut-out of the inlet plate is pressed onto the lateral surface of the terminating ring.

It can further be provided that the conveying device is designed as a belt conveyor, that the belt conveyor comprises a deflecting body about which the conveyor belt is deflected in the inlet region of the roller gap in order to allow a feeding of the dough strip into the inlet region and the roller gap, that the inlet plate has a strip cut-out whose shape substantially corresponds to the contour of the conveyor belt in the inlet region and that in the operating position of the inlet plate in the inlet region a gap is kept free between the strip cut-out of the inlet plate and the conveyor belt and that the strip cut-out of the inlet plate rests on the conveyor belt, that the pressure element has a slope over which the inlet plate is pressed in the direction of the front side of the second roller upon rotation of the clamping element about the lever axis and/or that two inlet plates are provided for lateral sealing of the roller gap and/or the inlet region of the roller gap, wherein the two inlet plates are provided on both sides in the region of the front sides of the rollers, wherein optionally the second roller is connected movably to the machine frame and is movable relative to the first roller.

The device according to the invention comprises an inlet plate which is designed to be movable. The movability is determined in particular by the kinematics of the moving device. The moving device allows a movement of the inlet plate from an operating position into a maintenance position. In the operating position the inlet plate is disposed in such a manner that it laterally seals the inlet region of the roller gap and optionally the roller gap itself.

To this end it is placed sealingly on, for example, two components of the device. One of the components is the second roller or a component which is sealingly connected to the second roller. The second component is the first roller or a component which is sealingly connected to the first roller.

A clamping device is provided as a counterholder against the pressure of the dough strip to be rolled out. This clamping device clamps the inlet plate to seal the roller gap against the aforementioned components. Preferably the inlet plate is designed to be flexible or at least movable so that it can be moved to a slight extent from a first position in which it can be moved and in particular folded away, into a sealing position. To this end preferably a movement or bending of the inlet plate in the axial direction of the rollers is made possible.

The apparatus according to the invention preferably comprises a movable roller. Due to the movability of at least one roller the width and/or the shape of the roller gap can be varied. Preferably the second roller is designed to be movable. To this end it is advantageous if the inlet region and optionally the roller gap is sealed in the region of the front side of the second roller. It is thereby possible that the inlet plate pressed onto the front side maintains the seal with substantially radial movement of the second roller and a sealing contact is always given. Advantageously as a result the roller gap and in particular the width of the roller gap can be varied when the device is running, i.e. when dough strip is fed through. The seal of the inlet region and optionally the roller gap is always maintained by the inlet plate even when the rollers are moving.

To this end, the front side of the roller preferably follows a normal plane of the axis of rotation of this roller. The inlet plate also has a surface which lies substantially parallel to this or in this plane.

The device according to the invention is suitable and/or adapted to be used in-line in an industrial production plant for food products. The invention is described further hereinafter with reference to the figures.

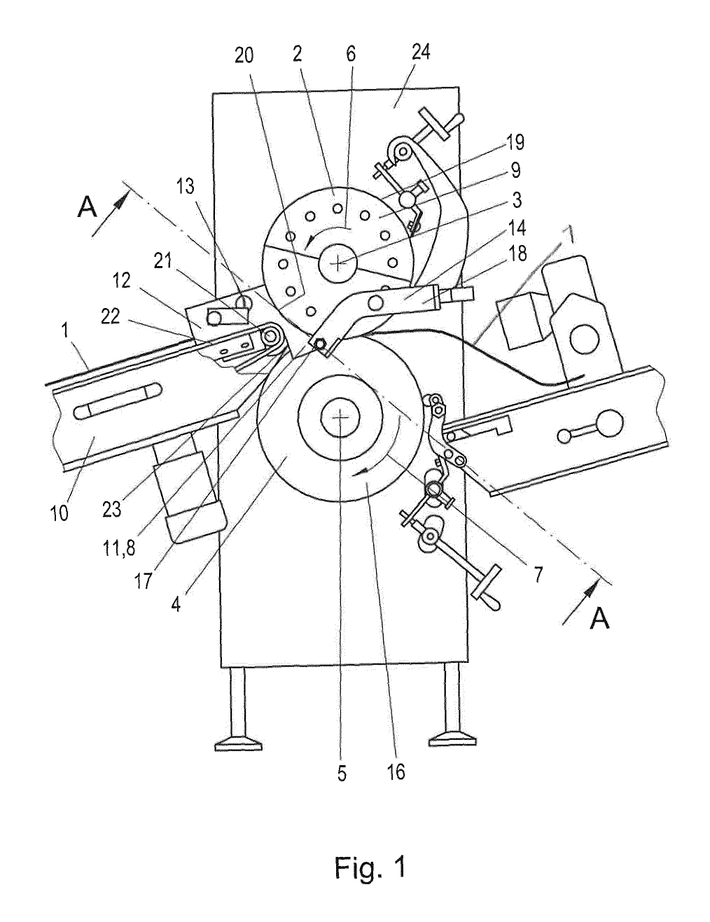

FIG. 1 shows a schematic side view of the device according to the invention where the front side panel of the machine frame is faded out.

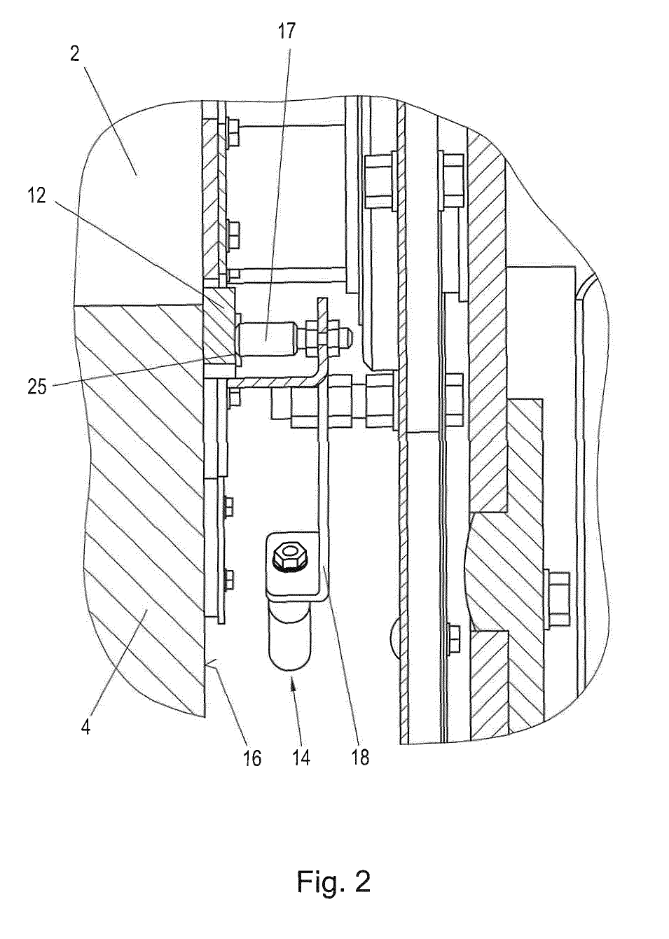

FIG. 2 shows the detail of the inlet plate according to line of intersection A-A from FIG. 1.

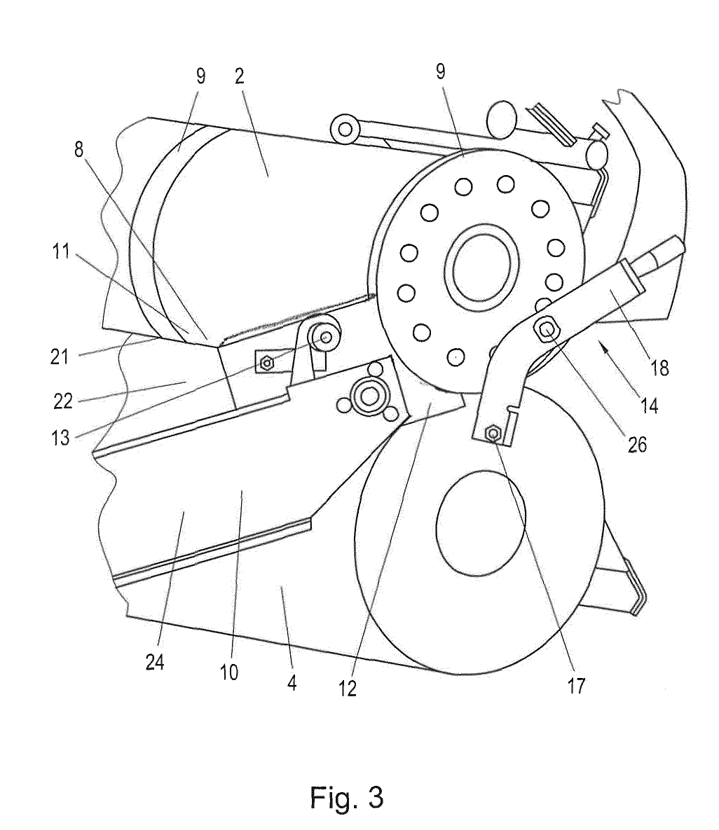

FIG. 3 shows an oblique view of the device with the clamping device folded away.

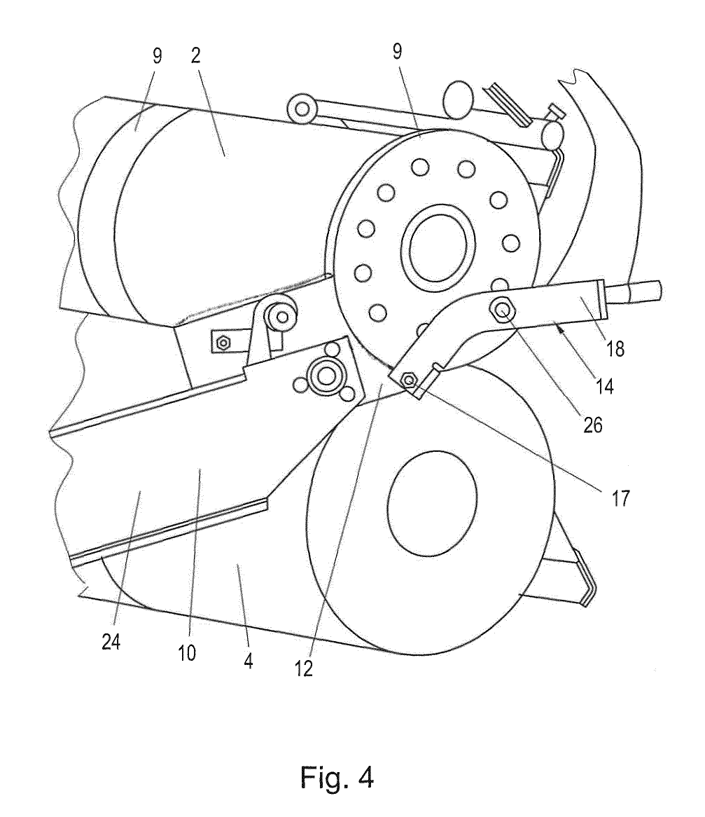

FIG. 4 shows the same view as FIG. 3 but with the roller gap sealed.

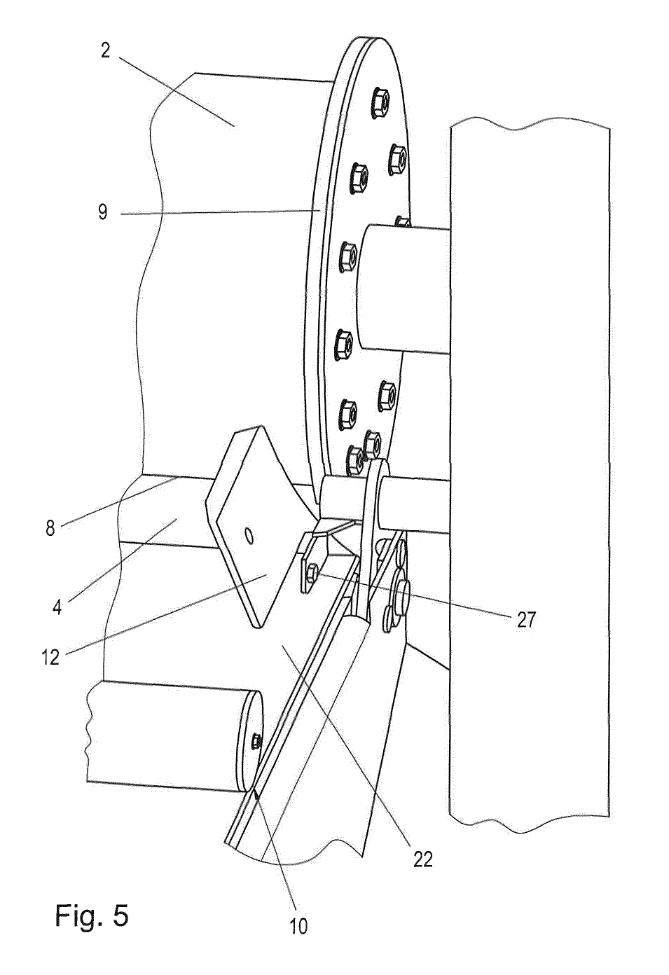

FIG. 5 shows a schematic oblique view of the device with the inlet panel folded away.

FIG. 1 shows an embodiment of the device according to the invention in which a dough strip 1 is guided through a first roller 2 and a second roller 4. A conveying device 10 is provided for supplying the dough strip 1 which in the present diagram is shown schematically and not in its complete size. The conveying device 10 comprises a conveyor belt 22 which is deflected around a deflecting body 21. The conveyor belt 22 is preferably driven by means of a drive. At the deflecting body 21 the dough strip 1 leaves the conveyor belt 22 and is conveyed through the inlet region 11 into the roller gap 8. The roller gap 8 is substantially defined by that opening which is formed between the two rollers 2, 4, the lateral inlet plates 12 and the terminating rings 9. The first roller 2 has a first axis of rotation 3 which in the present diagram runs in a projecting manner.

The second roller 4 has a second axis of rotation 5 which also runs in a projecting manner. However, the two axes of rotation 3 and 5 can possibly easily be restricted.

According to a preferred embodiment, the second roller is designed to be movable with respect to the first roller. In particular this relates to the spatial position of the two axes of rotation of these rollers with respect to one another. Thus, the roller gap can be changed in its size and optionally its shape. The inlet plate 12 according to the invention is provided in order to enable the seal even in the event of a change in the position of the rollers with respect to one another.

The first roller 2 has a direction of rotation 6 which is opposite the direction of rotation 7 of the second roller 5. As a result, the dough strip 1 is conveyed through the roller gap 8. The first roller has a terminating ring 9 at the side. This ring projects beyond the first roller 2 in the radial direction. In the present embodiment in the region of the roller gap 8, the terminating ring 9 also projects beyond parts of the second roller 4. As a result the roller gap is laterally at least partially sealed. However, the terminating ring 9 cannot be configured to be arbitrarily large in order to also seal the inlet region 11 of the roller gap 8 since otherwise this would be structurally in conflict with the conveyor belt 22 of the conveying device 10. For this reason the inlet plate 11 according to the invention is disposed to be movable.

In the present view the inlet plate 11 is located in the operating position. This means that in the position shown the roller gap and the inlet region 11 of the roller gap 8 are sealed. The inlet plate 12 is connected to the machine frame 24 via a moving device 13. In particular, the inlet plate is designed so that it can be folded away over the moving device 13. The inlet plate 12 has a cut-out 20. This is cut out substantially round, where the curvature of the cut-out 20 substantially corresponds to the radius of curvature of the lateral surface 19 of the terminating ring 9. As a result of a linear or flat contact of the cut-out 20 on the lateral surface 19 of the terminating ring 9, a sealing connection is achieved. During rotation of the first roller 2 and stationary inlet plate 12, relative movement and possibly sliding friction occurs between the two said elements.

Furthermore, the inlet plate 12 has a strip cut-out 23. The strip cut-out 23 has a shape which substantially corresponds to the contour of the conveyor belt 22 in the inlet region 11. In the operating position shown, a narrow gap can be provided between the strip cut-out 23 of the inlet plate 12 and the conveyor belt 22. According to a further embodiment, the strip cut-out 23 of the inlet plate 12 can contact the conveyor belt 22.

For sealing with respect to the second roller 4 the inlet plate 12 is pressed by means of a clamping device 14 against the front side 16 of the second roller 4. The clamping device 14 comprises a clamping element 17 and a lever 18. The lever 18 has an axis of rotation about which it is rotatably disposed. The inlet plate 12 can be pressed against the front side 16 of the second roller 4 by means of the clamping element 17.

FIG. 2 shows the clamping device as a detail section of the sectional profile A-A. The second roller 4 is shown cutaway and disposed in the immediate vicinity of the first roller 2. The inlet plate 12 is pressed onto the front side 16 of the second roller 4 in order to effect a seal. The pressure is transferred by the clamping element 17 onto the inlet plate and further to the front side 16 of the second roller 4. In the present embodiment, the clamping element 17 projects from the lever 18 of the clamping device 14. In the present embodiment the clamping element 17 has a slope 25. If the lever is turned about the lever axis 26, the clamping element 17 moves away from the inlet plate 12 and the inlet plate loses the contact on the second roller. This is accomplished on the one hand by means of a slight elastic pre-stressing of the inlet plate but possibly also through the movement of the rollers. If the inlet plate 12 should now be clamped for sealing, the lever 18 of the clamping device 17 is thrown so that the clamping element 17 is brought into the region of the inlet plate 12. In order to avoid a hooking or a blocking of the clamping element 17 and the inlet plate 12, the clamping element 17 has a slope 25. With incipient contact of the clamping element 17 on the inlet plate 12, the edge of the inlet plate 12 slides along the slope 25, whereby the inlet plate 12 is pressed against the second roller 4. Optionally also—or only—the inlet plate 12 can have a slope in order to build up a compressive force effected by relative movement.

FIG. 3 shows a schematic oblique view of a detail of the device according to the invention. The first roller 2 and the second roller 4 are rotationally mounted and driven according to the preceding description and positioned at a distance from one another. The roller gap 8 is provided between the two rollers 2, 4. At least on one side, preferably on both sides respectively one terminating ring 9 is provided laterally delimiting the first roller 2. This terminating ring 9 projects beyond the first roller 2 circularly in the radial direction. Furthermore, the terminating ring 9 preferably also projects beyond at least a part of the second roller 4. As a result, the roller gap is at least partially laterally sealed. The conveying device 10 comprises a conveyor belt 22 which is deflected around a deflecting body 21. At least one inlet plate 12 is provided for sealing the inlet region 11 of the roller gap 8. Preferably two inlet plates 12 are provided which laterally seal the inlet region 11 and the roller gap 8 on both sides. The inlet plate 12 is connected via a moving device 13 to the machine frame 24. This makes it possible to fold away the inlet plate 12. Furthermore a clamping device 14 is provided. This is also disposed or supported on the machine frame 24. However the part on which the clamping device 14 is provided is faded out in the present view. The connection between the machine frame 24 and the lever 18 of the clamping device 14 is accomplished via the lever axis 26. As a result, the lever 18 is disposed rotatably. The clamping element 17 is provided protruding from the lever 18. This protrudes in the direction of the inlet plate 12. FIG. 3 shows the clamping device 14 in the folded away position. In this case, no contact of the clamping element 17 and the inlet plate 12 takes place. On the contrary the clamping element 17 points into a free region remote from the inlet plate 12.

FIG. 4 shows the same arrangement but in a different position. Here the clamping device 14 and in particular the lever 18 is rotated about the lever axis 26 in such a manner that the clamping element 17 is in contact with the inlet plate 12 and presses this onto the front side 16 of the second roller 4. The remaining seal of the gap is accomplished via the terminating ring 9 of the first roller 2.

FIG. 5 shows the same arrangement as FIGS. 3 and 4 but with the inlet plate 12 folded away. This is located in the maintenance position in which on the one hand the conveyor belt 22 of the conveying device 10 can be changed and on the other hand the roller gap 8 between the first roller 2 and the second roller 4 can be maintained.

The inlet plate 12 is folded away in such a manner that it is no longer pressed onto the second roller 4. In the folded-away position there is also no contact with the second roller 2 or with the terminating ring 9 of the second roller. Optionally a connecting device 27 can be provided for fastening the inlet plate 12. In the diagram in FIG. 4 and FIG. 5 this connecting device is executed as a simple screw connection. To this end a holder with a through hole is provided on the machine frame. A screw can be inserted through this through hole which can be screwed in an opening of the inlet plate 12. The clamping and sealing of the roller gap, in particular with respect to the second roller 4, is accomplished according to the preceding description via the clamping device 14.

According to a further embodiment not shown, the inlet plate 12 can be pivoted away by means of an arbitrary kinematic arrangement of, for example, a pivoting lever. Optionally the inlet plate can also be completely removed.

In all the embodiments an inlet plate is provided which is preferably made of plastic or, for example, of bronze. In principle, any material is suitable which can be designated as sliding material in the technical sense and which has sufficient stiffness against the pressure of the dough strip to be rolled out. In particular, it is important that at the contact points with the moving parts, i.e. for example, with the second roller or the ring of the first roller the friction is kept low by a suitable material pairing. For example, this is achieved by a pairing of plastic/steel, bronze/steel or similar sliding pairings.

### REFERENCE LIST:

1 Dough strip
2 First roller
3 First axis of rotation
4 Second roller
5 Second axis of rotation
6 Direction of rotation of the first roller
7 Direction of rotation of the second roller
8 Roller gap
9 Terminating ring
10 Conveying device
11 Inlet region
12 Inlet plate
13 Moving device
14 Clamping device
15 Pressure element
16 Front side of second roller
17 Clamping element
18 Lever
19 Lateral surface
20 Cut-out
21 Deflecting body
22 Conveyor belt
23 Strip cut-out
24 Machine frame
25 Slope
26 Lever axis
27 Connecting device

1-10. (canceled)

11. An apparatus forming a flat rolled-out continuously conveyed dough strip, the apparatus comprising:
a first roller rotationally driven about a first axis of rotation;
a second roller rotationally driven about a second axis of rotation in a direction of rotation opposite a direction of rotation of said first roller;
said first and second rollers being disposed to form a roller nip in between for feeding through and rolling out a dough strip;
a terminating ring disposed concentrically with said first roller and projecting in a radial direction for lateral sealing of said roller nip;
a conveying device for supplying the dough strip to an inlet region of said roller nip;
a movable inlet plate connected to a machine frame by way of a moving device, said inlet plate being movable by said moving device from an operating position, in which said inlet plate laterally seals the inlet region of the roller nip, into a maintenance position, in which said inlet plate is disposed at a distance from the roller nip; and
a clamping device configured for moving said inlet plate onto said second roller in the operating position.

12. The apparatus according to claim 11, wherein said clamping device comprises a pressure element configured to press said inlet plate onto a lateral front side of said second roller to seal the inlet region of the roller nip.

13. The apparatus according to claim 11, wherein said clamping device comprises a movable clamping element on which said pressure element is provided for pressing said inlet plate onto said second roller by movement of said movable clamping element.

14. The apparatus according to claim 13, wherein said movable clamping element includes a lever pivotally mounted to the machine frame, and said pressure element projects laterally from said lever.

15. The apparatus according to claim 11, wherein:
said terminating ring has a lateral surface with a given curvature;
said inlet plate has a circular-section-shaped cut-out with a radius of curvature substantially equal to a radius of the given curvature of said lateral surface of said terminating ring; and
said cut-out of said inlet plate is pressed onto the lateral surface of said terminating ring in the operating position.

16. The apparatus according to claim 11, wherein said conveying device is a belt conveyor comprising a deflecting body about which a conveyor belt is deflected in the inlet region of said roller nip in order to feed the dough strip into the inlet region and into said roller nip.

17. The apparatus according to claim 16, wherein:
said inlet plate is formed with a strip cut-out having a shape substantially corresponding with a contour of said conveyor belt in the inlet region; and wherein:
in the operating position of said inlet plate, a gap is maintained in the inlet region between said strip cut-out of said inlet plate and said conveyor belt; or
said strip cut-out of said inlet plate rests on said conveyor belt.

18. The apparatus according to claim 11, wherein said pressure element has a slope by way of which said inlet plate is pressed in a direction of a front side of said second roller upon rotation of said clamping element about the lever axis.

19. The apparatus according to claim 11, wherein said inlet plate is one of two inlet plates for lateral sealing of said roller nip and/or of said inlet region of said roller nip, and wherein said two inlet plates are provided on both sides in a region of the front sides of said first and second rollers.

20. The apparatus according to claim 11, wherein said second roller (4) is connected to the machine frame movably relative to said first roller for varying a width of a shape of said roller nip when said inlet plate is pressed on.

21. The apparatus according to claim 20, wherein said second roller is movable parallel to said first roller or inclinable relative to said first roller.
